(19) United States
(12) Patent Application Publication
(10) Pub. No.: US 2016/0172992 A1
(43) Pub. Date: Jun. 16, 2016

(54) AC DRIVE SCR AND RELAY PRECHARGING APPARATUS

(71) Applicant: Rockwell Automation Technologies, Inc., Mayfield Heights, OH (US)

(72) Inventors: Rangarajan Tallam, Germantown, WI (US); Doyle F. Busse, Jackson, WI (US); Alia Rebecca Strandt, Hales Corners, WI (US)

(73) Assignee: Rockwell Automation Technologies, Inc., Mayfield Heights, OH (US)

(21) Appl. No.: 14/571,436

(22) Filed: Dec. 16, 2014

(51) Int. Cl. H02M 5/458

(52) U.S. Cl. CPC H02M 5/458

(57) ABSTRACT

Power converters are presented having a precharging resistance and a normally closed precharging switch with a controller to limit inrush current during precharging of a DC bus circuit capacitance while preventing operation of rectifier switching devices until the DC bus voltage reaches a threshold value, and then to open the precharging switch and allow selective operation of the rectifier switching devices, with a second capacitance coupled across a rectifier output to mitigate rectifier output voltage spikes due to common mode currents flowing through a DC link choke, and additional capacitors coupled between positive and negative rectifier output terminals and ground to limit the rectifier output terminal voltages with respect to ground.

### BACKGROUND INFORMATION

The subject matter disclosed herein relates to power conversion, and more specifically to precharging circuitry for motor drives and other power converters.

### BRIEF DESCRIPTION

Various aspects of the present disclosure are now summarized to facilitate a basic understanding of the disclosure, wherein this summary is not an extensive overview of the disclosure, and is intended neither to identify certain elements of the disclosure, nor to delineate the scope thereof. Rather, the primary purpose of this summary is to present various concepts of the disclosure in a simplified form prior to the more detailed description that is presented hereinafter. The present disclosure provides precharging systems for limiting inrush current while charging a DC bus capacitance through a normally closed switch and a precharging resistance with a controller to open the precharging switch and enable rectifier switches when the DC bus voltage reaches a threshold. In addition, the disclosure provides circuitry to mitigate voltage spikes in excessive rectifier output voltages to ground.

### BRIEF DESCRIPTION OF THE DRAWINGS

The following description and drawings set forth certain illustrative implementations of the disclosure in detail, which are indicative of one or more exemplary ways in which the various principles of the disclosure may be carried out. The illustrated examples are not exhaustive of the many possible embodiments of the disclosure. Various objects, advantages and novel features of the disclosure will be set forth in the following detailed description when considered in conjunction with the drawings, in which:

FIG. 1 is a schematic system diagram;

FIG. 2 is a schematic diagram;

FIG. 3 is a schematic diagram; and

FIG. 4 is a flow diagram.

### DETAILED DESCRIPTION

Referring now to the figures, one or more embodiments or implementations are hereinafter described in conjunction with the drawings, wherein the various features are not necessarily drawn to scale.

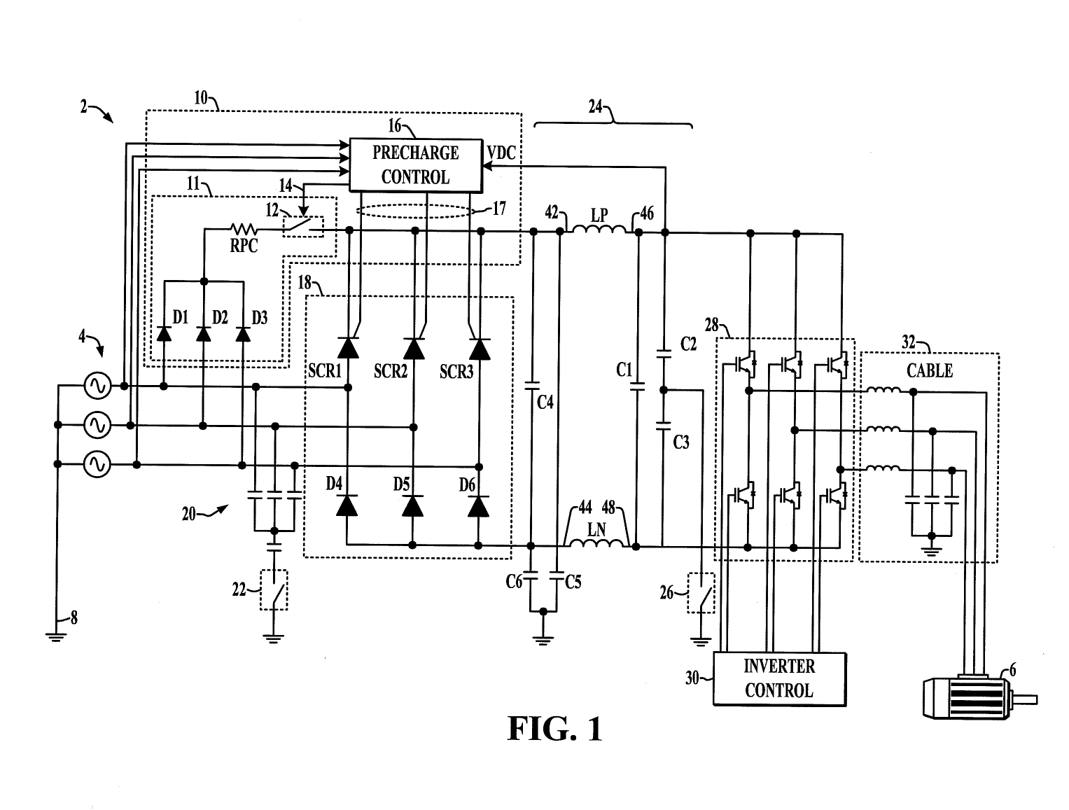

FIG. 1 shows a power converter or power conversion system 2, in this case a motor drive, with an output switching inverter 28 providing a multiphase variable frequency AC output to drive a motor load 6 through a cable 32. The various concepts of the present disclosure are illustrated and described in the context of a motor drive type power conversion system 2. However, the present disclosure is not limited to motor drives and can be implemented in various forms of power conversion systems having a single or multiphase switching inverter, including without limitation motor drives, grid-tie converters, wind energy systems, etc. The drive 2 receives multiphase AC input power from an external source 4 at an AC input of a rectifier 18 which converts the received power to provide a DC bus voltage in an intermediate DC bus circuit 24, although other embodiments are possible in which single phase input power is provided to the system 2. In addition, the illustrated system 2 receives a three-phase input, but other multiphase embodiments are possible.

The system 2 also includes a precharging system 10 with a precharging circuit 11 having diodes D1, D2 and D3 along with a precharging resistance RPC and a normally closed switch circuit 12 operated according to a switching control signal 14 from a precharging controller 16, where the precharging diodes D1-D3 have anodes connected to corresponding AC input lines and cathodes connected to the precharging resistance RPC as shown. The rectifier 18 in the illustrated embodiment includes an upper set of switching rectifiers, which can be SCRs SCR1, SCR2 and SCR3 as shown or other suitable controllable switching devices coupled between a corresponding AC input line and an upper rectifier output node 42, along with rectifier diodes D4, D5 and D6 with anodes coupled to a second (e.g., negative) rectifier output node 44 and cathodes connected to corresponding AC input lines.

The intermediate DC bus circuit 24 includes upper and lower (e.g., positive and negative) DC link inductances LP and LN, respectively, connected between the first and second rectifier outputs 42 and 44 and positive and negative DC bus nodes 46 and 48 respectively forming first and second inverter inputs of the switching inverter 28. A DC bus capacitance C1 is coupled between the inverter input nodes 46 and 48. In operation, the precharging system 10 maintains the precharged switching circuit 12 in the normally closed state and prevents the upper rectifier SCRs SCR1 , SCR2 and SCR3 from conducting using SCR control signals 17 upon system power up until the voltage VDC across the DC bus capacitance C1 meets or exceeds a non-zero threshold voltage VTH1. At this condition, the precharged controller 16 opens the precharging switch circuit 12 to discontinue conduction through the resistance RPC and allows gating of the SCRs of the rectifier 18 for normal rectifier operation to maintain the DC bus voltage across the capacitance C1. The DC bus voltage VDC is provided across the inverter inputs 46 and 48, with the inverter 28 including switches (e.g., IGBTs, FETs, or other suitable form of electrical switches) operated by suitable control signals from an inverter controller 30 to provide a controlled AC output through the cable 32 to operate the motor load 6 according to one or more desired output operating parameters, such as output speed or frequency, torque, etc.

The precharge controller 16 and the inverter controller 30 and the components thereof may be implemented as any suitable hardware, processor-executed software, processor-executed firmware, logic, and/or combinations thereof wherein the illustrated controllers 16 and 30 can be implemented using processor-executed software or firmware providing various control functions by which the inverter controller 30 receives feedback and/or input signals and/or values (e.g., setpoint(s)) and provides inverter switching control signals to provide AC output power to drive the load 6. Furthermore, the precharged controller 16 in certain embodiments operates according to DC bus voltage feedback (VDC) in order to perform the precharged and rectifier control functionality as set forth herein. In addition, the controllers 16 and 30 and the components thereof can be implemented in a single processor-based device, such as a microprocessor, microcontroller, FPGA, etc., or one or more of these can be separately implemented in unitary or distributed fashion by two or more processors.

As discussed further hereinafter, moreover, the system 2 includes a second capacitance C4 coupled between the first and second rectifier outputs 42 and 44, as well as a third capacitance C5 coupled between the first rectifier output 42 and the ground node 8, as well as a fourth capacitance C6 coupled between the second rectifier output 44 and the ground node. A switchable capacitor bank 20 is coupled with the AC input, and a switch 22 is provided for selectively coupling the input capacitor bank 20 with a ground or other constant voltage node 8, such as the grounded neutral of the external source 4 in the illustrated embodiment. In addition, the illustrated system 2 includes a DC bus capacitor circuit including DC bus common mode capacitances C2 and C3 connected in series between the inverter input nodes 46 and 48, with a center node joining C2 and C3 being selectively coupled to the ground node by a switch 26. The common mode capacitances C2 and C3 may be connected in the circuit by closing the switch 26 to provide a low impedance path for return of common mode currents to avoid having those currents return to the power source 4 for systems in which the neutral of the source 4 is grounded to the ground node 8 as shown in FIG. 1. In addition, the AC input capacitances 20, when the switch 22 is closed, also provide a low impedance path for return of common mode currents without going through the AC source 4. The common mode capacitances C2 and C3 and the AC capacitors 20 are useful in practice, particularly for very low inverter output frequencies (e.g., low motor speeds) in combination with high pulse width modulation frequency operation of the inverter 28 and long cable lengths 32, in which relatively large common mode currents can conduct. Thus, the switches 22 and 26 advantageously facilitate operation of the system 2 in a variety of situations for easy tailoring to a given end use application.

The inventors have appreciated that opening the switches 22 and 26 for grounded source systems allows undesirable, mode currents to return to the power source neutral through the ground connection 8. However, other system configurations are possible, such as high resistance grounding (HRG) connections, floating system configurations, etc., in which the DC bus capacitors C2 and C3 are removed from the circuit by opening the switch 26. In this situation, particularly for low motor speeds, long cables 32 and relatively high inverter operating frequencies, the AC input line currents are typically low, and may not be enough to latch the upper rectifier SCRs in the on state. In this condition, moreover, if the common mode current returns back through the power source 4 or to the AC input lines through the AC input capacitors 20 with switch 22 closed, and the upper rectifier SCRs SCR1, SCR2 and SCR3 are not latched on, the common mode current returns through the precharge circuit diodes D1-D3 and conducts through the precharged resistance RPC, which can lead to overheating of the precharged resistance RPC absent opening of the switch 12.

In addition, since the intermediate DC bus circuit 24 includes the DC link choke LP, LN connected between the rectifier output nodes 42, 44 and the inverter input nodes 46, 48, without the capacitance C4, the voltage at the rectifier output can be significantly different than the DC bus voltage across C1 because common mode currents flow across the inductances LP, LN, and the rectifier output node voltages can deviate significantly from ground without the use of capacitances C5 and C6. For example, the nominal DC bus level across C1 for a three-phase 480 V input source 4 may be around 650 V, and the rectifier output voltage may spike to about 1300 V in certain conditions absent the use of the third capacitor C4. In certain embodiments, therefore, the third capacitor C4 dampens voltage spikes at the output of the rectifier 18, wherein C4 is about 0.1 μF in one non-limiting embodiment. Moreover, the common mode capacitors C5 and C6 in one embodiment can be relatively low capacitances, such as about 10 nF in one implementation, to limit the peak rectifier output voltages to ground 8.

In order to mitigate undesirable overheating of RPC during normal operation, therefore, the precharging system 10 provides a normally closed switching circuit 12 operated according to the control signal 14 from the precharge controller 16 in order to open the switch 12 when the DC bus voltage VDC exceeds a threshold, and concurrently the upper rectifier SCRs SCR1, SCR2 and SCR3 are allowed to operate by switching control signals 17 from the controller 16 to be selectively activated to begin normal rectifier operation. Furthermore, the use of a normally closed switch 12 advantageously maintains the precharging conduction path through RPC at power up before the precharge controller 16 is fully operational. In certain embodiments, moreover, the same signal 14 that gates the SCRs of the rectifier can be used to open the switch 12.

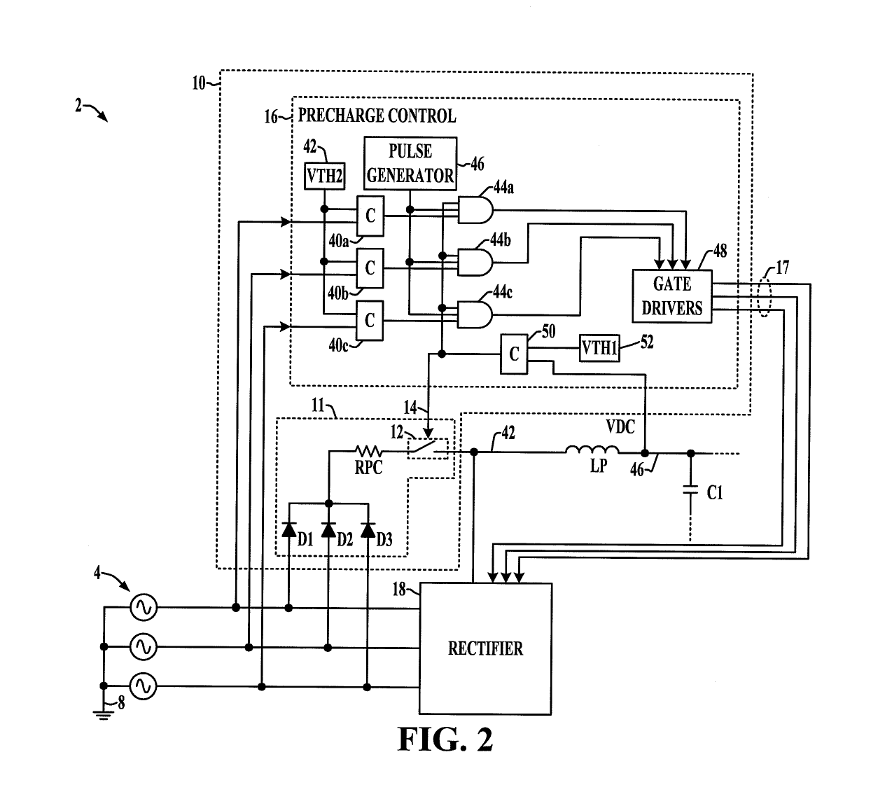

FIG. 2 illustrates a non-limiting precharging system embodiment 10, in which the precharged controller 16 implements selective phase-specific gating control of the upper rectifier SCRs SCR1, SCR2 and SCR3 using techniques illustrated and described in U.S. Pat. No. 8,154,895 to Gilmore, assigned to the assignee of the present disclosure, the entirety of which is hereby incorporated by reference. In particular, the precharge controller 16 in FIG. 2 includes three comparator circuits 40a, 40b and 40c individually operative to compare the AC input line voltages of the corresponding input phases with a second threshold voltage VTH2, and provide outputs to corresponding three-input AND gates 44a, 44b and 44c. The AND gates 44 each receive a further input from a pulse generator 46 as well as a further input from the switching control signal 14 used to operate the precharging switch 12. The outputs of the AND gates 44 are provided to gate driver circuits 48 for provision of the SCR control signals 17.

As discussed in the incorporated U.S. Pat. No. 8,154,895, the upper rectifier SCRs are individually actuated via the control signals 17 when the switching control signal 14 is active (e.g. HI in one example) and when the corresponding AC input phase voltage is the highest positive between the three input phase voltages during the positive portion of the pulse signal provided by the pulse generator 46. In this manner, the control signal 14 enables operation of one or more of the SCRs of the rectifier 18 and opens the switch 12 when activated. As shown in FIG. 2, moreover, the precharge controller 16 also receives a DC bus voltage feedback signal representing the voltage VDC across the DC bus capacitance C1 as an input to a comparator 50. The DC bus voltage VDC is compared with the first threshold voltage VTH1, which is a non-zero positive voltage in the illustrated embodiment, and the switching control signal 14 is asserted HI when the DC bus voltage VDC is greater than or equal to the threshold voltage VTH1. Otherwise, if VDC is less than the threshold VTH1, the precharging switch 12 is maintained in the closed position to allow conduction through RPC to precharge C1, and the SCR control signals 17 are disabled.

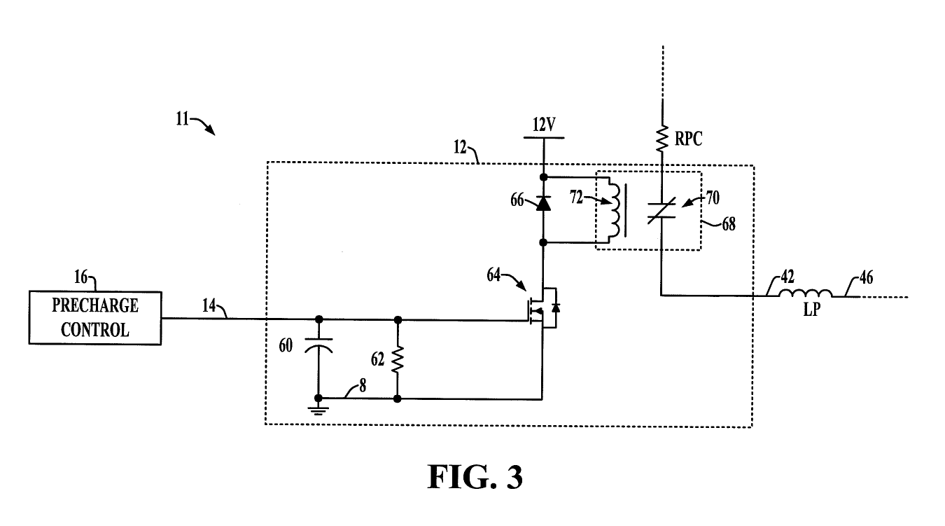

FIG. 3 illustrates an embodiment of the precharge switching circuit 12, including an input receiving the control signal 14 from the precharge controller 16, with a capacitor 60 coupled in parallel with a resistance 62 between the input 14 and the ground 8 to filter the switching control signal 14 and provide an input to a gate control terminal of an N-channel field effect transistor 64. The source of the transistor 64 is connected to the ground terminal 8, and the drain of transistor 64 is coupled to a lower terminal of a normally closed control coil 72 of a relay 68 whose upper terminal is connected to a positive voltage, such as 12 V DC in one non-limiting example. A diode 66 is connected across the coil 72, with the anode connected to the drain of the transistor 64 and the cathode connected to the 12 V supply node. The relay 68 further includes a normally closed (NC) contact 70 connected between the precharging resistor RPC and the first rectifier output node 42. When the switching control signal 14 goes active HI in this embodiment, the transistor 64 turns on, thereby pulling the lower terminal of the control coil 72 to ground 8, thus energizing the coil 72. This opens the normally closed contact 70, thereby preventing conduction through the precharged resistance RPC.

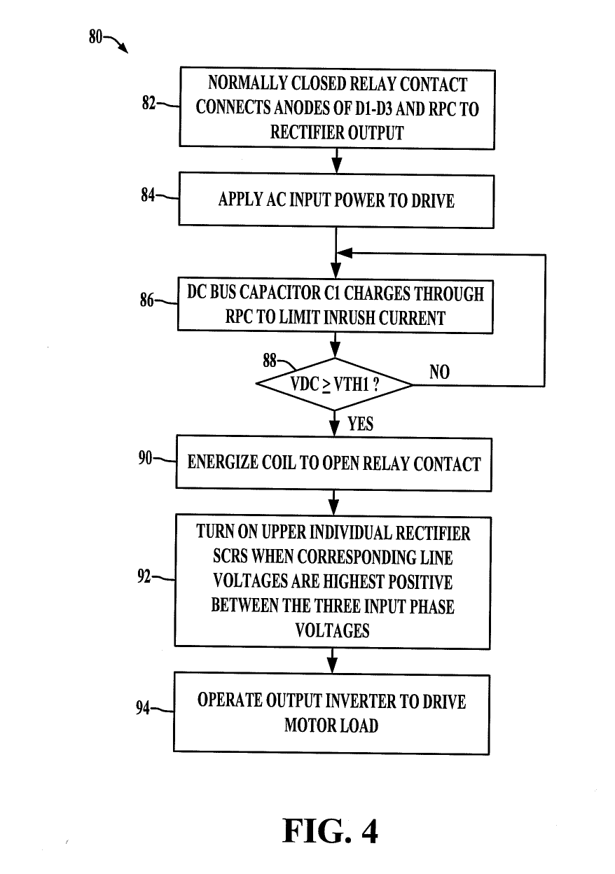

FIG. 4 illustrates a process 80 for operating the precharging system 10 and the rectifier SCRs of the system 2, beginning from an unpowered condition. At 82 in FIG. 4, the normally closed relay contact (e.g., contact 70 in FIG. 3 above) connects the anodes of D1-D3 and the precharging resistor RPC (e.g., FIG. 1 above) to the rectifier output node 42. At 84 in FIG. 4 AC input power is applied to the drive system 2, and the DC bus capacitor C1 charges through the precharging resistance RPC at 86 to limit inrush current. The controller 16 determines at 88 whether the DC bus voltage VDC across the bus capacitance C1 is greater than or equal to the first threshold voltage VTH1. If not (NO at 88), the DC bus capacitor charging continues at 86. Once the DC bus voltage VDC meets or exceeds the threshold (YES at 88), the controller 16 energizes the coil 72 (FIG. 3) at 90 by asserting the switching control signal 14 to open the relay contact 70. At 92 in FIG. 4, the assertion of the signal 14 also turns on the upper individual rectifier SCRs when the corresponding line voltages are the highest positive between the three input phase voltages, for example, using the comparators 40 and the AND Gates 44 in FIG. 2 above. Thereafter at 94, the output inverter 28 is operated according to switching control signals from the inverter controller 30 to drive the motor load 6.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. This description uses examples to disclose various embodiments and also to enable any person skilled in the art to practice the disclosed subject matter, including making and using any devices or systems and performing any incorporated methods. It will be evident that various modifications and changes may be made, and additional embodiments may be implemented, without departing from the broader scope of the present disclosure as set forth in the following claims, wherein the specification and drawings are to be regarded in an illustrative rather than restrictive sense.

The following is claimed:

1. A precharging system for precharging a DC bus circuit of a power conversion system, the precharging system comprising:
a precharging circuit, including:
a plurality of diodes with anodes connected to AC input lines,
a precharging resistance having a first terminal coupled with cathodes of the diodes, and
a switching circuit coupled between a second terminal of the precharging resistance and a first rectifier output node and operative when a switching control signal is in a first state and when no switching control signal is provided to allow charging current to flow from at least one of the AC input lines through the precharging resistance to at least partially precharge the DC bus circuit, the switching circuit operative when the switching control signal is in a different second state to prevent current flow through the precharging resistance; and
a precharge controller providing the switching control signal to the switching circuit in the first state when a DC bus voltage of the DC bus circuit is less than a non-zero threshold voltage, and to provide the switching control signal to the switching circuit in the second state when the DC bus voltage is greater than or equal to the threshold voltage.

2. The precharging system of claim 1, wherein the switching circuit includes a relay comprising a normally closed contact coupled between the second terminal of the precharging resistance and the first rectifier output node, and a coil operative to selectively open the normally closed contact when the coil is energized.

3. The precharging system of claim 2:
wherein a first terminal of the coil is coupled with a supply voltage; and
wherein the switching circuit comprises a transistor coupled between a second terminal of the coil and a constant voltage node, the transistor comprising a control terminal receiving the switching control signal from the precharge controller to prevent energization of the coil when the switching control signal is in the first state and when no switching control signal is provided, and to selectively energize the coil to open the normally closed contact when the switching control signal is in the second state.

4. The precharging system of claim 2, wherein the precharge controller provides the switching control signal to prevent operation of switching devices of a rectifier of the power conversion system when the switching control signal is in the first state, and to selectively operate the switching devices of the rectifier when the switching control signal is in the second state.

5. The precharging system of claim 4, wherein the precharge controller comprises a comparator providing the switching control signal to the switching circuit in the first state when the DC bus voltage is less than the threshold voltage, and in the second state when the DC bus voltage is greater than or equal to the threshold voltage.

6. The precharging system of claim 1, wherein the precharge controller provides the switching control signal to prevent operation of switching devices of a rectifier of the power conversion system when the switching control signal is in the first state, and to selectively operate the switching devices of the rectifier when the switching control signal is in the second state.

7. The precharging system of claim 6, wherein the precharge controller comprises a comparator providing the switching control signal to the switching circuit in the first state when the DC bus voltage is less than the threshold voltage, and in the second state when the DC bus voltage is greater than or equal to the threshold voltage.

8. The precharging system of claim 1, wherein the precharge controller comprises a comparator providing the switching control signal to the switching circuit in the first state when the DC bus voltage is less than the threshold voltage, and in the second state when the DC bus voltage is greater than or equal to the threshold voltage.

9. A power conversion system, comprising:
a rectifier comprising:
an AC input,
a DC rectifier output with first and second rectifier outputs, and
a plurality of rectifier switching devices coupled between the AC input and the first rectifier output;
an inverter with first and second inverter inputs for receiving DC input power, and an inverter output for providing AC output power to drive a load;
a DC bus circuit, comprising:
a bus capacitance coupled between the first and second inverter inputs, and
an inductance with a first terminal coupled with the first rectifier output and a second terminal coupled with the first inverter input;
a precharging circuit, comprising:
a plurality of diodes with anodes connected to the AC input,
a precharging resistance having a first terminal coupled with cathodes of the diodes, and
a switching circuit coupled between a second terminal of the precharging resistance and the first rectifier output and operative when a switching control signal is in a first state and when no switching control signal is provided to allow charging current to flow from the AC input through the precharging resistance to at least partially precharge the bus capacitance, the switching circuit operative when the switching control signal is in a different second state to prevent current flow through the precharging resistance; and
a controller providing the switching control signal to the switching circuit in the first state when a DC bus voltage across the bus capacitance is less than a non-zero threshold voltage, and to provide the switching control signal to the switching circuit in the second state when the DC bus voltage is greater than or equal to the threshold voltage.

10. The power conversion system of claim 9, wherein the switching circuit includes a relay comprising a normally closed contact coupled between the second terminal of the precharging resistance and the first rectifier output, and a coil operative to selectively open the normally closed contact when the coil is energized.

11. The power conversion system of claim 10:
wherein a first terminal of the coil is coupled with a supply voltage; and
wherein the switching circuit comprises a transistor coupled between a second terminal of the coil and a constant voltage node, the transistor comprising a control terminal receiving the switching control signal from the controller to prevent energization of the coil when the switching control signal is in the first state and when no switching control signal is provided, and to selectively energize the coil to open the normally closed contact when the switching control signal is in the second state.

12. The power conversion system of claim 9, wherein the controller provides the switching control signal to prevent operation of the rectifier switching devices when the switching control signal is in the first state, and to selectively operate the rectifier switching devices when the switching control signal is in the second state.

13. The power conversion system of claim 9, comprising a second capacitance coupled between the first and second rectifier outputs.

14. The power conversion system of claim 13, comprising:
a third capacitance coupled between the first rectifier output and a constant voltage node; and
a fourth capacitance coupled between the second rectifier output and the constant voltage node.

15. The power conversion system of claim 9, comprising:
a third capacitance coupled between the first rectifier output and a constant voltage node; and
a fourth capacitance coupled between the second rectifier output and the constant voltage node.

16. A power conversion system, comprising:
a rectifier comprising:
an AC input,
a DC rectifier output with first and second rectifier outputs, and
a plurality of rectifier switching devices coupled between the AC input and the first rectifier output;
an inverter with first and second inverter inputs for receiving DC input power, and an inverter output for providing AC output power to drive a load;
a DC bus circuit, comprising:
a bus capacitance coupled between the first and second inverter inputs,
an inductance with a first terminal coupled with the first rectifier output and a second terminal coupled with the first inverter input, and
a second capacitance coupled between the first and second rectifier outputs;
a precharging system, comprising:
a plurality of diodes with anodes connected to the AC input,
a precharging resistance having a first terminal coupled with cathodes of the diodes, and
a normally closed switch circuit coupled in series with between a second terminal of the precharging resistance and the first rectifier output; and
a controller operative in a first state to maintain the switch circuit closed and to turn off the rectifier switching devices when a DC bus voltage across the bus capacitance is less than a non-zero threshold voltage, and to open the switch circuit and to allow operation of the rectifier switching devices when the DC bus voltage is greater than or equal to the threshold voltage.

17. The power conversion system of claim 16, comprising:
a third capacitance coupled between the first rectifier output and a constant voltage node; and
a fourth capacitance coupled between the second rectifier output and the constant voltage node.

18. The power conversion system of claim 17, wherein the switch circuit comprises:
a relay comprising a normally closed contact coupled between the second terminal of the precharging resistance and the first rectifier output; and
a coil including a first terminal coupled with a supply voltage; and
a transistor coupled between a second terminal of the coil and a constant voltage node;
wherein the controller provides a control signal to the transistor to prevent energization of the coil when the DC bus voltage is less than the non-zero threshold voltage, and to selectively energize the coil to open the normally closed contact when the DC bus voltage is greater than or equal to the threshold voltage.

19. The power conversion system of claim 16, wherein the switching circuit includes a relay comprising a normally closed contact coupled between the second terminal of the precharging resistance and the first rectifier output node, and a coil operative to selectively open the normally closed contact when the coil is energized.

20. The power conversion system of claim 19:
wherein a first terminal of the coil is coupled with a supply voltage; and
wherein the switching circuit comprises a transistor coupled between a second terminal of the coil and a constant voltage node, the transistor comprising a control terminal receiving the switching control signal from the precharge controller to prevent energization of the coil when the switching control signal is in the first state and when no switching control signal is provided, and to selectively energize the coil to open the normally closed contact when the switching control signal is in the second state.
